(19) United States
(12) Patent Application Publication
(10) Pub. No.: US 2011/0071915 A1
(43) Pub. Date: Mar. 24, 2011

(54) System and method for searching and merging compatible applications from a user-influenced search result for portable electronic drvice

(75) Inventors: Jonathan C. Lee, Malibu, CA (US); Xochitl Hwang, Marina Del Rey, CA (US)

(73) Assignee: Onionmap, Inc., Culver City, CA (US)

(21) Appl. No.: 12/923,413

(22) Filed: Sep. 21, 2010

Related U.S. Application Data
(60) Provisional application No. 61/272,410, filed on Sep. 22, 2009.
(60) Provisional application No. 61/272,409, filed on Sep. 22, 2009.

(51) Int. Cl. G06Q 30/00

(52) U.S. Cl. 705/26.1

(57) ABSTRACT

A system and method for allowing a user to keep and maintain compatible application on a single application on a portable electronic device that allows the user to organize, maintain, categorize, merge and personalize the downloaded compatible content application on a single platform. The current invention allows the user to search for and download compatible content from a content provider, whereby merged content or application becomes part of user's customized application, giving content providers a one-on-one interaction with the user, and in return, the content provider pays the inventive platform operator a fee when a user views, accesses, merges, downloads, or engages in commercial activity, wherein the search result from the inventive platform is user-influenced in that the more a compatible application of a content provider is viewed, merged or commercial activity performed, the higher its rank.

### PRIOR APPLICATIONS

This current application is a utility application, filed from and benefiting from the two (2) earlier filed U.S. Provisional Applications: (1) Application No. 61/272,410, filed Sep. 22, 2009, titled Map Based Interactive Search Platform; and (2) Application No. 61/272,409, filed Sep. 22, 2009, titled OSAT-GEOCODE Translation Engine. All of the disclosures of these two Provisional applications are incorporated herein by reference.

### BACKGROUND

With existing search technology, such as searches available through Google or Yahoo, various deficiencies and shortcoming exit. A search using the available technology displays too many results and provides too many choices, making most of the results meaningless and redundant. It is not unusual for a Google search to identify over a million search results. Furthermore, the results are listed in a non visual manner, making the job of culling through the enormous volume of information difficult and time consuming.

The adword technology as employed by Google and Yahoo have provided for a more targeted search result. Yahoo first, then Google, used a pay-by-placement method to search for and display search results. For the search engine companies, this technology was lucrative, and from the advertisers, it allowed their advertisements to be displayed higher in the results. Also for the user, it helped manage the search results data displayed. But even with adwords, there are significant deficiencies. For example, even after accessing the relevant information from the Internet, a user cannot easily save the relevant content found. A user must conduct the search again at a later time to access the data.

Existing search technology is deficient in that the search process is time consuming and inefficient, and that even when the relevant information is found, a user has difficulty in retaining the content found. The searching process using a search engine is a time-consuming multi-step process. For example, in a typical search, a user takes the following steps to find relevant content: access the search engine; insert search term(s); obtain search results; read through each search result; narrow and determine which web site to access; once in the website, explore the different pages within the website to find the most relevant information; exit a target website and go back to the search results page; review the search result list; pick another website; and repeat this process until the right website is chosen. It is time consuming and not easily ascertainable where the most relevant content is located. The user's experience and the results obtained are limited by deficiencies in search technology. There is also no customization or personalization of the search experience. Results displayed do not depend on any user doing the search.

Also, present search technology also lacks intelligent memory or a method for keeping the targeted content found through search. Available search technology does not save the search results. Even with bookmarking, getting to the bookmark or a search history, especially after a significant time lapse, is a tedious and burdensome process. The bookmark itself or search history may no longer be available. Also, the user must remember that a site has been bookmarked. Even then, the user must open up the Internet browser, click on the bookmark list, access the site of interest, and after obtaining the site, surf within the various pages in the site to find the content that the user is searching for, then exit and go back to previous activity. In the sea of redundant information, the user may or may not find what was being sought even after going through the multi-step process of searching and navigating through all of the information.

In recent years, mobile telephone applications have developed at an accelerated rate and have evolved quickly. Their increasing popularity and their varied capabilities have made them a practical necessity for modern life. Applications, also known as “apps”, remedy some of the deficiencies of search in that they provide shortcuts to highly relevant content and information without requiring the user to conduct a search each time. Apps provide information and functionalities that are specifically tailored, eliminating the need for search and some of the deficiencies associated with search.

But there are deficiencies in and limitations in apps as well. For example, various apps downloaded from various content providers are disconnected and disjointed. Even for various applications on a user's mobile smart phone, the user must navigate in and out of various applications to obtain the necessary information. A user goes through the arduous process of searching for an app, reviewing the results, making a decision on relevancy, and repeating this process until ultimately finding the most relevant app, data, or information. For example, a user may go through multiple tasks in a day, such as waking up with an alarm clock on the smart phone, checking weather before dressing, checking traffic before commuting to work, and checking news while eating breakfast, and using the navigation app while driving to work for directions. All of these items can be done on a handheld/mobile computer device, but there is no one portal where all of these items can be accessed by a simpler method. For each of the various apps that service each need, such as checking for traffic or providing news, each app is discrete and independent of the other. The user must often exit one app, or suspend viewing one app, access another app, then navigate between the different apps.

Further, a user is not able to easily share search results with the user's community base. For example in Facebook, everyone has a personal page, but these pages are not customizable, they are not portable, and search results or content obtained from the Internet is not easily transferable or shared with another user. There are no functions to allow different accounts to be merged. The existing technology does not provide a secure setting upon which information can be exchanged safely. Content obtained by a user is not easily or often shared with different parties.

### BRIEF DESCRIPTION OF THE DRAWINGS

FIG. 1 illustrates a schematic view of a display for creating a Point of Interest in the inventive application.

FIG. 2A is a schematic partial view of a map-styled display of the inventive application on a mobile smart phone.

FIG. 2B is a schematic view of a folder view or a list view display of the inventive application.

FIG. 2C is a schematic view of a tree-view display of the inventive application.

FIG. 3A is an illustrative example of the results of a search being displayed on the inventive application.

FIG. 3B is an illustrative example of a compatible application of a content provider after having been merged onto user's inventive application.

FIG. 4A is an illustrative example of folders and subfolders shown within a content provider's application comprising information and functionalities.

FIG. 4B is the example shown in FIG. 4A displayed in a schematic tree view.

FIG. 5 is an illustrative process for planning a birthday dinner using the inventive application.

FIG. 6A is a schematic view of the user interface for reserving a hotel using the inventive application.

FIG. 6B is a schematic view of the user interface for reserving car rental services using the inventive application.

FIG. 7A is a schematic view of the user interface for purchasing a product from a vendor using the inventive application.

FIG. 7B is a schematic view of the user interface for purchasing tickets to an opera using the inventive application.

FIG. 8A is a schematic view of the user interface for purchasing airline tickets using the inventive application.

FIG. 8B is a schematic view of the user interface for purchasing tickets to the Eiffel Tower using the inventive application.

FIG. 9A is a schematic view of the user interface for obtaining information about a convention center using the inventive application.

FIG. 9B is a schematic view of the user interface for a Las Vegas travel content provider's application using the inventive application. This can also be a user's travel plans to Las Vegas.

FIG. 10 is a schematic view of the user interface in a tree view of the travel plans shown in FIG. 9B with a menu of functions such as Search, Merge, etc.

### DESCRIPTION

The present invention concerns a mobile telephone platform, method, and application that allow a user to keep, maintain and customize the most relevant information and application to the user throughout the day in a single application platform. The current invention allows the user to download any compatible relevant content or application, such as use information or functionalities, from compliant sites of interest and content providers, who provide the compatible content for searching, viewing, accessing, downloading and merging onto the user's personalized platform, whereby the merged content becomes part of the user's customized application. Providers of compatible content (such as information and functionalities) gain access to one-on-one interaction with a would be consumer or user, and in return, the subscribing content provider pays the providers of the inventive platform a fee for a user's viewing, accessing, merging, downloading, or conducting commercial transaction on or using said application.

The displays on said inventive mobile telephone application comprises one or more points of interest, referred to herein as POI, which are geocode based and therefore assigned geospatial information, wherein each of said POI can be displayed in one or more methods as known in the art, including but not limited to, using symbols, photos, drawings, or any other method of designating a place, topic of interest, item, person, or object, among others. As the display of the present invention usually contains various POIs, the display itself can be organized in one or more alternative views or displays.

Among such views of displays include but are not limited to a display background of a map, scalable or non-scalable, wherein said map may be a depiction of a real map or resemble a geographical map, or may be a schematic map or a symbolic map showing identifiable or easily recognizable geographical or location evoking features. In other embodiments, the display can be organized into other categorization methods for display, such as in a list or outline format or in folders, or in a schematic format such as a display depicting a tree with various branches further subdividing into sub-branches. This latter embodiment is referred to as a tree view with branches, sub-branches, and so on.

The present invention is advantageous in that the user is able to keep the user's most relevant and useful information and functionalities in a single application or display. Also a user can organize and personalize the display in a format to suit the user's preferences. When additional information or functionalities are desired, for example the user may want to find information about a car dealership, the user searches for available compatible applications for viewing, downloading, and merging into the user's personalized inventive application.

For example, a car dealership may provide compatible application that is viewable and downloadable for merging onto the uniquely customized display of the user, becoming a part of the user's display and application, wherein the vendor's content is merged into and displayed on the user's customized display for access. Once the compatible content is no longer as relevant, the user is able to simply archive or organize the content away from the display screen for later use or recall.

The present invention is advantageous for the content provider such as an advertiser in that it provides a highly unique one-on-one connection, whereby the content is provided only to the users specifically requesting the information, and wherein the requested content merges onto the user's inventive application, giving the content provider continued access and interaction. For the user, the present invention is advantageous in that the user avoid unsolicited advertisement and information not requested by the user. Also, the present invention is advantageous in that the user is not bombarded with a sea of options. In a preferred embodiment, only vendors and content providers having compatible downloadable content/application are displayed, thereby further narrowing the search results, with the implication that only those who have spent the resources and energy in configuring and investing in useful compatible applications will be chosen.

The content provider or advertiser preferably creates compatible content for merging into the inventive platform. Said content can be information organized in simple and easily accessible manner and also may contain functionalities for use by the user, such as functionalities for making reservations, for making purchases, for giving feedback, and for any other interactive function as known in the art. Once the compatible content/application is merged into the user's customized display, it can be accessed by the user directly on the user's own display.

The current invention is advantageous in that it uses a single platform. The content provider's content/application must preferably be in format compatible with the inventive application. A user does not need to access different web sites for information or download different apps on a smart phone. A content provider or a vendor's content can be viewed, accessed, downloaded, and merged indirectly onto the inventive application. Unlike existing technology, where various discrete searches are conducted without merging or saving of useful information, the current invention allows the user to retain useful content found using a search.

Furthermore, the current invention is advantageous in that the user controls the advertisement and content received. The current invention is unique in that content is provided for only when requested by the user. The user is not bombarded with unsolicited information without the express consent of the user. Therefore, the content searched for accessed, and ultimately downloaded and merged into the user's platform, is highly relevant and desired by the user. There is no generalized, shot-gun approach to advertising, resulting in a much higher user experience and efficiency.

Because the inventive platform functions on a cellular telephone, all the advantages of current telephone and wireless technology can be used to implement and carry out the various embodiments of the invention. For example, compatible content downloaded from a vendor can have functionality that allows the vendor to update information downloaded or otherwise provide for real-time information based on the user's location, time, and preferences among others. In one embodiment, the current invention provides services that are delivered in real time-specific, preference-specific, event-specific, and/or location-specific manner.

The advertisement method of the current invention charges advertisers, vendors, and content providers only when the user comes directly in contact with the Advertiser's product and services. In one embodiment, certain content providers, such as public entities, educational entities, and otherwise non-commercial content providers can be provided a fee waiver. In the current invention, exposure to advertisement will be initiated and controlled by the user. Advertisement generally will preferably not be presented to the user without the user's permission or request.

Also, in a preferred embodiment, rather than downloading all the information or functionalities available on any given content provider's website, only limited information containing the most relevant information is preferably downloaded. Content downloaded is therefore streamlined and relatively succinct as compared to all the content available on the vendor's website. For example, for a large manufacturer such as Harley Davidson, downloadable compatible content may not have all the information provided on the vendor's full service website but instead may contain a more abbreviated content and functionalities.

Furthermore, content itself being viewed and downloaded for merging may also be customized according to the user's preferences. For example, if the user is interested in not purchasing a Harley Davidson motorcycle but is interested in only researching different models available, the user may select a content package for download that provides information on the different models, with only a limited functionality for purchasing a motorcycle. In contrast, a user who knows what model he or she wants may specifically access, view, and download content that allows the buyer to engage more fully in the purchase or negotiating process.

As discussed herein, compatible content is understood to mean that the content provided by the content provider is compatible with the inventive application. The content (information or functionalities) must preferably be viewable, accessible, downloadable, and merge-able onto the inventive platform to allow the user to use the inventive application with the content provider's application.

Also, one or more various portions of a user's platform may be shared. Businesses can share a portion of a ‘tree’ with another business or with a customer. A “user” for the purposes of our invention can also refer to a business or any other organization or entity or an individual. In one embodiment, a user can share any one or more portion of the user's tree. Business and Personal data can be exchanged and merged.

In the one-on-one advertisement revenue method, the user's customization is preferably free of charge. Individual users can download the inventive application and software on their mobile telephone and customize their interface for free. The inventive application can be downloaded preferably from the website of the operator/provider of the inventive application or through some other method as known in the art, for example through the Google® App store or the Apple® App store, or through any other delivery or installation methods. After downloading the application or purchasing a mobile phone that has this application already installed, the user then customizes the display to the user's preference. The user can create various POIs, assign geocode where applicable, and build a display using the inventive application to create an individualized and customized display.

In a preferred embodiment, there is no charge to the user for downloading or using any of the compatible vendor applications. In this embodiment, the user does not pay the provider of the inventive application at any time. Instead, the compatible content/application provider, who may be an advertiser, pays the providers or operator of the inventive application. The inventive platform operator gets paid when a business' application is viewed, accessed, downloaded, merged or when a business function is performed (schedule appointment, purchase made, survey taken, service used, make reservation, etc.) Whenever the business' application is viewed or accessed by a user, inventive platform operator is preferably paid. Whenever the business' application is merged onto the user's application, invention platform operator gets paid. Terms of payment may be agreed to in advanced or are determined as known in the art through a bidding process or via commission or through any other known method of electronic commerce payment method.

Vendors and content providers may preferably also establish an account free of charge from the inventive application operator. A commercial vendor or a content provider of compatible content also builds out a viewable, accessible, downloadable, and merge able account or application free of charge. The inventive application provider/operator may reside on an Internet website that allows the content provider to establish an account and create a compatible content application free of charge as known in the art. In one embodiment, the content provider will provide credit card or other payment information so that the inventive application provider can be paid upon a user viewing, accessing, downloading or merging the content provider's compatible application. The content provider would preferably agree to the terms of payment and method of payment as established or as negotiated between the inventive application provider and content provider(s). Such payment methods can be determined using one or more various methods as known in the art, including but not limited to fixed pricing per occurrence of an event, fixed pricing per group of events, a percentage fee, an auction-style bidding arrangement, among others.

The content provider can be a commercial vendor, seller of product or service, any information provider, or any advertiser of any kind, among others. The content provider can also customize the content/application to be provided to the user. The content can be information about the content provider, other necessary information about the location of the vendor, information about services and products, and other functionalities, such as reservation system, an interactive interface, such as games, reviews, and any other application or functionality as known in the art. In other embodiments, a third party or even the inventive application provider can create compatible content for the content provider or advertiser.

As an alternative embodiment, an automated method as known in the art would allow compatible content to be created. In another embodiment, an automated method first creates compatible content, which is then further modified or edited by the content provider or the inventive application provider.

The content provider may also preferably configure the compatible application to be able to communicate directly with the content provider following downloading or merging by the user. In this manner, as known in the art, whether via using Wi-Fi or through the telephone service provider's wireless service or some other data transfer method, the content provider is preferably able to communicate directly with the user by updating information or providing additional functionalities without interruption and in a seamless manner.

A content provider (such as an e-commerce vendor or advertiser) can also create several alternative downloadable applications. The user may also be given a choice to pick and choose to customize the downloadable content as desired. Thus, in one embodiment, the downloadable application itself may be customized by the user. For example, some information and functionalities made available may be useful to the user but not others. There may also be certain information/functionalities that are set to be included with a compatible application, for example, contact information and directions to vendor's physical address, geocode information, brief description, and title, etc. Other information/functionalities, such as detailed maps, transactional functionalities such as user interfaces that allow the user to choose or input information or make order or purchases, may be a default inclusion or an option for inclusion in the download by the user. Various one or more fixed compatible applications may be available or various information/functionalities can be selected to create customized applications.

Preferably, search results using the inventive application display only content/application that are compatible with the inventive application. In one embodiment of the invention, when a user conducts a search within the inventive application, the results are selected only from sources having compatible application content. Thus, unless a vendor, advertiser, or content provider has created or has in possession a compatible application that is viewable, accessible, downloadable and/or merge-able with the inventive application, the search in the inventive application will not display content provided by the content provider. This assures that the most relevant content, provided by vendors, content providers, and advertisers, who are willing to pay to have their information viewed, thereby providing results of only those who have invested in the infrastructure as well as having invested in creating compatible application that would most likely be useful to the user. This also is advantageous in that the user is not inundated with an unlimited number of results, and the results are specific and targeted.

In one embodiment, the present invention allows personalized services, that are based on real-time information about the user can be used to provide appropriate information, services, prompts, or content to the user. For example, knowing the location of the user through the whereabouts of the handheld device, as known in the art, the inventive application or downloaded application of a content provider can provide time-specific, location-specific, event-specific, and/or preference-specific information to the user in real time. Thus, if the user for example is on the freeway and is driving to a certain location, as lunch is scheduled by the user, various options in close proximity to the destination can be delivered to the user, with rankings based on prior behavior and preferences of the user.

In one embodiment, content delivered such as prompts are pre-authorized by the user, who can set various parameters for items or types of content authorized to be delivered. For example, the user can pre-authorize or configure the user's personalized inventive application to notify the user any time a restaurant with four and a half stars ranking in Yelp is within a five mile vicinity of the user.

In another embodiment, the user's activities and past behavior, such as purchase histories, websites visited, and other activities using the mobile computing device can be delivered and/or used, as known in the art, by the inventive platform operator or a content provider to provide a more specific and targeted information to the user. Also, in another embodiment, demographics of the user, such as the user's age, sex, income level, area of residence, and other personal background information, including on-line behavior, may be used to deliver more targeted and relevant and personalized content. Further, in another embodiment, the inventive application provider/operator can gather and use the history of the user's activity, downloads, and all other relevant information as discussed, as known in the art, for commercial purposes with the content providers paying a fee to obtain such relevant information. Users can determine who/what/where/how to share and receive personal and business information.

The present invention preferably uses a personal portable computing device, but more preferably a mobile telephone device, as the device in which the current inventive application operates. Many ‘smart’ phones are available on the market today with ever increasing sophistication and usability. In a preferably embodiment, the present inventive application is used on a mobile telephone with a display screen size of 3.5 inches or larger, wherein the display screen is touch sensitive. The present invention applies to various smart phones and mobile computing devices as known in the art.

The current invention is advantageous in that it allows the user to closely track and follow their daily routines. The current invention preferably taps into and mirrors people's lives. People's activities and lives revolve around a fairly routine pattern or set of predictable events. People also live, for the most part, within the confines of a geographical area. The geocode based displays using POIs, whether scalable or non scalable, or whether displayed in a map or in some other manner, such as tree branches or even a list, knows the position of each POI in the display.

Thus, in an example, a user who lives out most of the user's life in a given radius can have various applications merged onto the inventive application. For example, in the example given just above, as the user is about to leave the home at a certain time, say between 7:00 a.m. and 7:30 a.m. on any given weekday that is not a holiday, the user's traffic report to and from work is provided to the user. The application that makes this possible may preferably have been downloaded and merged onto the user's inventive application from a traffic report content provider.

Also, for example, when work causes the user to travel outside of the normal range to Las Vegas once in a while, another categories or branches of content is downloaded and merged onto the user's inventive application. Examples of customizable and merge-able content and functionalities may include map-based applications that allow travel arrangements to be made, educational content, reservation functionalities, shopping information and purchase options, weather information, telephone functionalities, email functions, calendaring functions, instant messaging and video conferencing functions, among others.

The present invention also concerns possible tiers, layers, or themed displays, where the display can have different levels, tiers, layers, and themes that can be toggled back and forth, some allowing for greater detailed view of any given topic.

In one embodiment of the present invention, the inventive application allows for storage of daily life information such as text, photo, video, and chats. Search for new daily and future life information such as food, clothing, and other consumer goods and services can also be obtained. As the user encounters various needs throughout the day, the user is able to save new pieces of daily life information in one site.

In another embodiment of the present invention, social interaction between friends and family and colleagues, which occur more frequently through portable mobile devices, are also enabled and stored also on the same platform.

Furthermore, as the user's life experience grows day by day, the inventive application itself also grows and evolves. Not all the relevant data is merged and saved. Even for merged compatible applications, when its usefulness or relevance has expired, they can be stored away or archived away from immediate accessibility.

Content obtained with the present invention is not fragmented. Searches are remembered as the most relevant portions are directly downloaded and merged into the user's customized inventive application directly. Furthermore, various ‘branches’ of the invention can be shared.

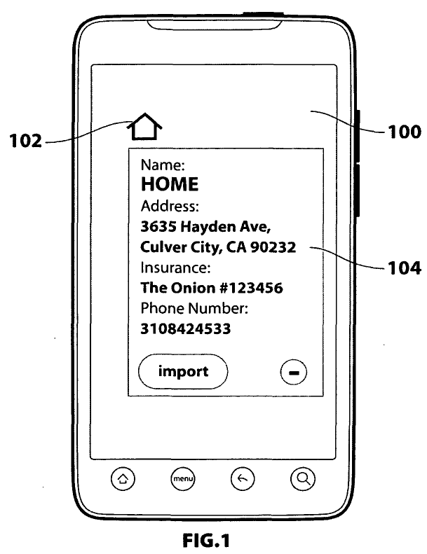

Referring now to the figures, FIG. 1 illustrates a method for creating a Point of Interest (“POI”) in the inventive application. Referring to FIG. 1, a background 100 is selected by the user. The user here in FIG. 1 may select a ‘city background’ (not shown). For example, the coastline for the Los Angeles area may be shown as a background. The user can choose form a variety of backgrounds. Various schematic displays, such as that shown by Onionmap.com, theme oriented background, season oriented background, POI oriented background, and city oriented background are examples.

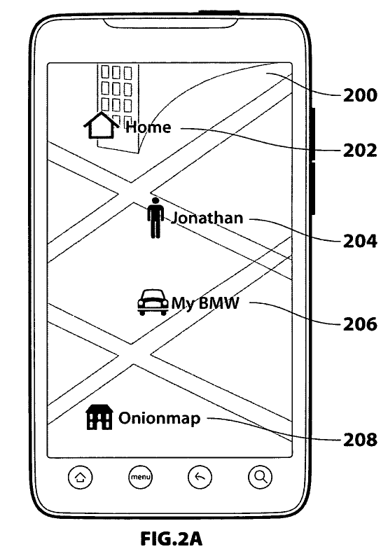

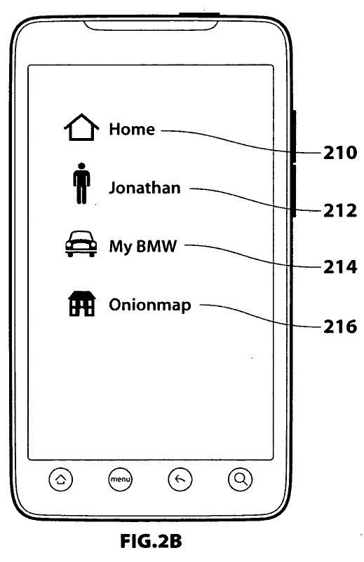

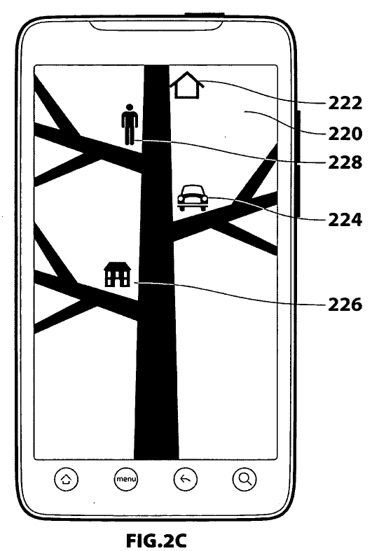

In FIG. 1, the user first sets the home icon 102 to indicate where the user lives. User selects a Home icon 102, which is shown as POI on the display. The display is chosen in the form of a schematic stick figure for a house showing walls, floor and roof. As seen in FIG. 1, various information about the “Home” is input into the POI. The address 104 allows for the inventive program to assign a geocode to the POI. So, regardless of whether the Home POI 102 is located in a map background as in FIG. 2A, or is simply listed in a folder view as in FIG. 2B, or in a schematic diagram of a tree in FIG. 2C, the POI has assigned to it a specific geospatial information that tells the inventive platform exactly where home is located. The geospatial information correlates the POI to a specific location in the real world or onto a correspondent place on a map, for example for display and location identification in a GPS enabled application.

FIG. 2A is a schematic partial view of a map-styled display of the inventive application on a mobile smart phone display screen. The map background 200 is shown, along with the various POIs 202, 204, 206, 208. Referring now to FIG. 2A, regardless of where the home 202 is, when the user carries the mobile phone home 202, it will know where the user is. The user's location will, in one embodiment, be assumed as being the location of the mobile phone. Various information about the user can be input into the inventive platform. Information can also be downloaded or synced with another software or portal containing the personalized information, such as Facebook, Twitter, Linkedin, Myspace or any other information data bank.

FIG. 2B is a schematic view of a folder view or a list view display of the inventive application showing various POIs 210, 212, 214, 216. The user can personalize the application background in a number of ways. FIG. 2A, FIG. 2B, and FIG. 2C are example of different ways the POIs of the inventive application as displayed on a mobile telephone interface/display. Various other POIs can be selected or created by the user, such as school, work place, school, supermarket, shopping mall, etc. The user can also input other individuals, such as family member, who can also be tracked by the mobile telephone carried by the person.

FIG. 2C is a schematic view of a tree-view display 220 of the inventive application. Any other schematic view may be used as known in the art. The tree view display shows the POIs 222, 224, 226, 228 of a user arranged in a tree shaped format with each large section of branches denoting a category, with further subdivisions or further branching depicting further subdivision of the category. For example, a branch depicted by a car POI 224 could further branch into a maintenance branch, a registration and license branch, a dealership branch, and so forth.

In one embodiment, the various views as exemplified by FIGS. 2A, 2B, and 2C, the map view, the list/folder view, and the schematic tree view, respectively, can be used as alternative views, wherein the user can toggle between the various views depending on preference. The user would be able to select the view desired.

The inventive application also allows the user to customize and organize the display in any manner as known in the art. For example in FIG. 2C, the various branches, groups of branches, each sub-branch or group of branches can be relabeled, regrouped, rearranged, or configured in a manner desired by the user. In an alternative embodiment, the user can choose to put all of the user's content in the inventive application on various branches forming one tree, or in the alternative, the user can have multiple separate trees with each depicting a different group or category. In the example shown in FIG. 2C, the various aspects of the user's life is allocated in a schematic manner as representing different branches of a tree. The home branch is the top branch shown in FIG. 2B. The car 224 branch and the work 226 branch, each have a separate branch on this tree.

Using FIG. 2C as an example, the user may have set up as her default display as the tree view 222 with the various categories of her life depicted as shown in FIG. 2C. If the user wishes to go and visit a zoo on a certain day with her children, the user can search for a zoo close by for her to visit that day proximate to her geographical location. When the user finds a desired zoo, she can download as a branch the zoo's compatible application content, which may have information and functionalities such as ticket purchase options. The Zoo's POI will then be displayed as a branch of a tress in FIG. 2C.

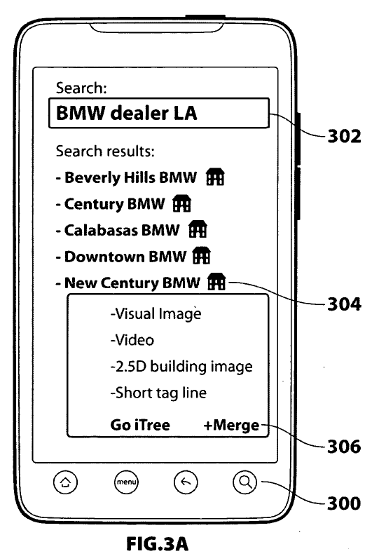

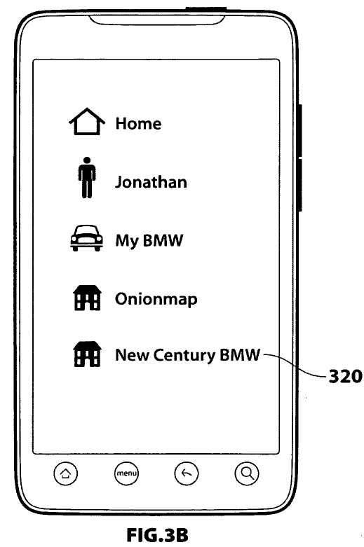

FIG. 3A is an illustrative example of the results of a search being displayed on the inventive application. Once the user uses the search engine within the inventive application to find a content provider who had compatible application content, the user can the merge the content provider's application into the user's customized inventive platform. In one embodiment, all of the information on the user's platform is backed up to a server maintained by the inventive application provider.

As shown in FIG. 3A, the user presses a search button 300 within the inventive application, which will bring up a data input area 302 for entering the search parameters in the input area provided. In the embodiment shown in FIG. 3A, the user is searching for a BMW dealership in the Los Angles area. The search results display five different BMW dealerships in the Los Angeles area. In this example, the user also lives and works in Southern California. So, the search pulls up information about BMW dealership in the most convenient locations.

The search results are displayed in FIG. 3A. The user can navigate through the search results in FIG. 3A to select the New Century BMW. Selecting the New Century BMW 304 further drops down a list showing more detailed information about New Century BMW 304, which can preferably be a preview of the content, information and/or functionalities, included in the downloadable application, which is compatible with the inventive application. Once the downloadable compatible application is found for the dealership at New Century BMW 304, the user then has the option of merging New Century BMW's compatible application directly onto the user's inventive platform.

In FIG. 3A, after viewing their product and services, and finding the desired content, user can download and merge the compatible application of New Century BMW in Los Angeles to the user's tree by selecting the “Merge” icon 306 on the lower right hand of the display. The New Century BMW tree is now merged into the user's personal tree.

FIG. 3B is an illustrative example of a compatible application of a content provider after having been merged onto user's inventive application. In this example, New Century BMW's compatible application has been downloaded into the user's personal inventive platform. The commercial vendor occupies a place directly on the user's interface as shown on his/or mobile telephone display. The New Century BMW branch 320 will be displayed on the user's mobile display screen at one of the branches, in the example shown in FIG. 2A. The user will then be able to have the New Century BMW information directly on the display screen of the inventive platform as displayed on the mobile telephone screen. The user can open the branch and obtain various information about products or services offered by New Century BMW 320.

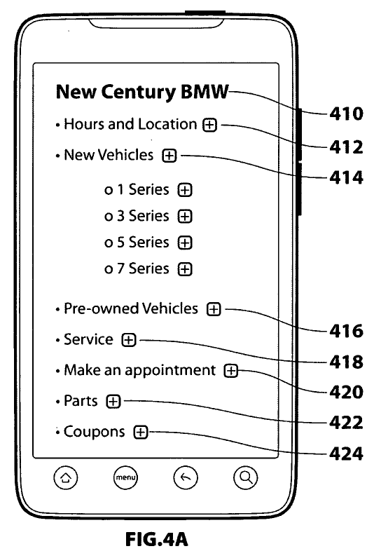

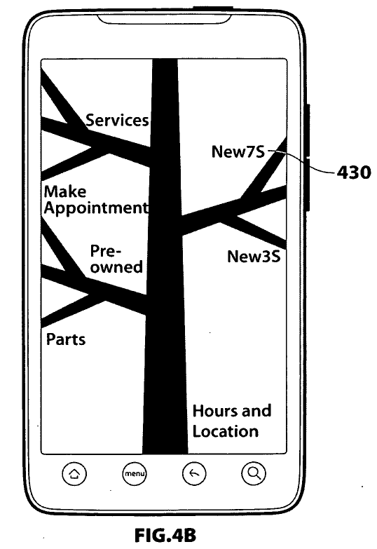

For example, as shown in FIG. 4A, once the New Century BMW POI 410 is selected, various additional content, information, and functionalities are shown. In FIG. 4A, hours and location 412 of the BMW dealership is shown, and information about new BMW models 414 can also be displayed. Furthermore, additional information such as pre-owned vehicles 416, services 418, appointments 420, parts 422, and coupons 424 are displayed. Should the user wish to make an appointment for service, the appointment 420 functionality can be selected to schedule a service appointment.

In one embodiment of the invention, information about the user or the user's automobile can also be sent by the user directly to the business directly in the form of a compatible application, or in an alternative embodiment, information about the user and the car is sent directly to the dealership.

In another embodiment, as shown in FIG. 4B, the vendor's information as shown in FIG. 4A is shown in a schematic diagram in the form of a tree branch in FIG. 4B. Various section headings for information and functionalities, similar to those in FIG. 4A are displayed in the branched format. From the user's main tree, the vendor's branch can be selected to reveal a further branching of the information as shown in FIG. 4B.

Selecting on any one or more topic will take the user to a display screen showing the requested information. For example, selecting “New7S” 430 will display information about the new BMW 7 series. The 7 series information page may be further subdivided into its own tree with various topics, such as model types, options, prices, photos, reviews, etc. (not shown). As seen in FIG. 4A, the display can be shown in a list or folder format. In one embodiment, the user can download only the portions of the BMW dealership's content as desired. The user may have an option to custom tailor the information included in the compatible content to be downloaded.

Once a service appointment is made, the vendor's tree may send reminders, send directions, allow user to make GPS guided trip to the dealership, allow the user to rate and give feedback to the BMW dealership, receive additional promotions, prompts, schedule future service appointments, send reminders about upcoming services and specials.

In this example as described, New Century BMW would pay the inventive platform operator a fee when its tree is first selected by the user, when it is accessed for further information, when its compatible application is downloaded, and/or when the compatible application is downloaded or merged onto the user's own inventive platform. Also, the vendor would pay the inventive platform operator when the user makes a service appointment using the merged vendor application. In each of these instances, a sum of money would be paid by New Century BMW to the inventive platform operator.

For the vendor, this system provides for a targeted, direct one-on-one, advertising to the user. For the user, the user controls the content, when and how to receive the content and how much of the content the user wishes to receive.

When the user is finished with visiting and getting her BMW service, the user can leave the New Century BMW tree on the user's personal tree or can archive or file away the vendor's tree/branch. Any method of archiving or storing or filing away the vendor's application as known in the art can be used. The vendor's application branch can be right within the user's main display until it is no longer relevant for the user. The vendor's application can simply be moved to a specific category, for example, under the category “cars” for the user. The vendor's application may also be updated wirelessly or through any other method and the content on the vendor's application can be updated.

In one embodiment, the vendor's compatible application content can also be shared. In the example in FIGS. 4A and 4B, the user may wish to purchase a BMW for the user's family member. Satisfied by the services at New Century BMW, the user searches for the vendor's downloaded application as may have been archived in the user's inventive application. Once the user searches for and finds the vendor's application, the user can share the application with his family member. Various methods as known in the art can be used, including but not limited to directly sending the user's application directly or sending a link directly to the family member so that the family member can directly access the vendor's site and download her own application. The benefit of receiving a copy of the user's own application may be that it will contain information about the user, preferences, previous history, and other information that can be used by the user's family member.

A content provider's content or application can be updated even after the download and merging by the user. As known in the art, through wireless connection, wired connection, or otherwise, the compatible application content can be updated by the content provider periodically or as the need arises. For example, if BMW comes out with another model in FIG. 4A, information about the new model may be added to the vendor's application. Also, if the hours of operation for the service department for the particular dealership changes, the change may also be reflected and updated in the user's downloaded application. Thus, the compatible content provider, whether a vendor or an advertiser or any other information provider, can preferably have an ongoing direct relationship with the user.

The content provider can also customize its own compatible application. The vendor, in this example a BMW dealership in the Los Angeles area as in FIGS. 4A and 4B, can specifically personalize its own application compatible with the inventive platform. Various customization as known in the art can be used by the vendors. Vendors can also make user-specific updates. Based on the information about the user, the vendor can make much more intelligent and targeted selections, information, and functionalities onto the downloaded application.

The present invention also contemplates real time personalize application. Some services are based on the user's preferences and some services are based on time, location and the event. This embodiment is a preference-time-event-location based application. On the day that a user may need to take the car to BMW service, the inventive application may send a reminder prompt to appear. As the user is driving to the BMW dealer, the user may have the GPS navigation system to give real time instructions on directions. After receiving car service, the user may also comment and give feedback to the dealership about the service. The information then can be sent to the dealership. The user can also save new service appointment to the user's calendar and ask for a reminder prompt. Once the user no longer needs the BMW branch, the user can archive or hide the branch until needed at a later time.

In another embodiment, the invention platform operator or any vendor or third party or even the user can create area specific or event specific applications. For example, businesses, cities, chambers of commerce, third party developers, and other individuals can build area specific or event specific application content that is compatible with the inventive application. For example, information, guides, and functionalities for an entire city can be built. Furthermore, a user can download and merge a branch onto its tree a branch called Las Vegas.

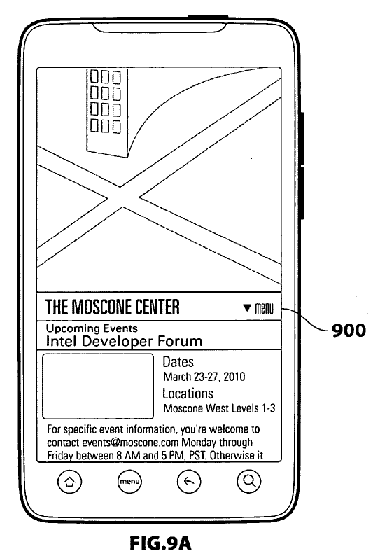

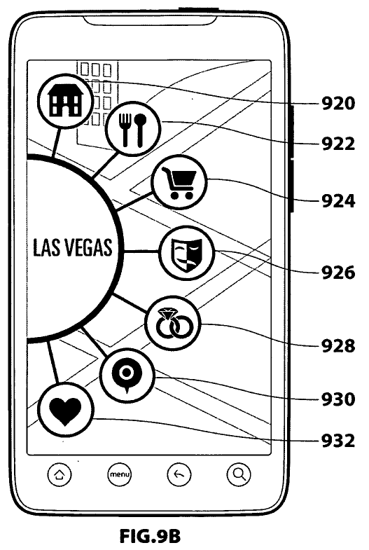

FIG. 9B shows a display as displayed on the operator/provider of the inventive application or as shown in a user's display. As shown in FIG. 9B, the initial display can have as branches various general categories, such as casinos/hotels 920, dining 922, shopping 924 928, entertainment 926, and wedding chapels 932, and other points of interest. By accessing the dining option may pull up an additional tree under the title dining 922, that showcases various types of dining options, such as buffets, cheap eats, restaurants based on review and prices. Each category of dining, when accessed, can have specific options for each eating establishment, and each restaurant can then have its own application that is compatible with the inventive platform and provide further useful information such as menu, reviews, photos, address, hours, and directions, as well as functionalities such as reservations and feedback systems.

Other embodiments may include event-specific trees, for example an event specific tree for a certain food festival, show casing all the different available vendors at the festival, emergency contacts, map of facilities, specials from vendors, description and history of festival, etc.

In yet another embodiment, a location-specific tree may enable shoppers at a specific shopping mall to have specific trees that will provide information on the various stores on site, specials and sales, and other functionalities.

As with other embodiments of the invention, these various embodiments allow vendors or information providers to make one-on-one specific contact with the users, the users control the flow of information, and the vendors are paid if and when information is accessed, received, or purchases are made by the user.

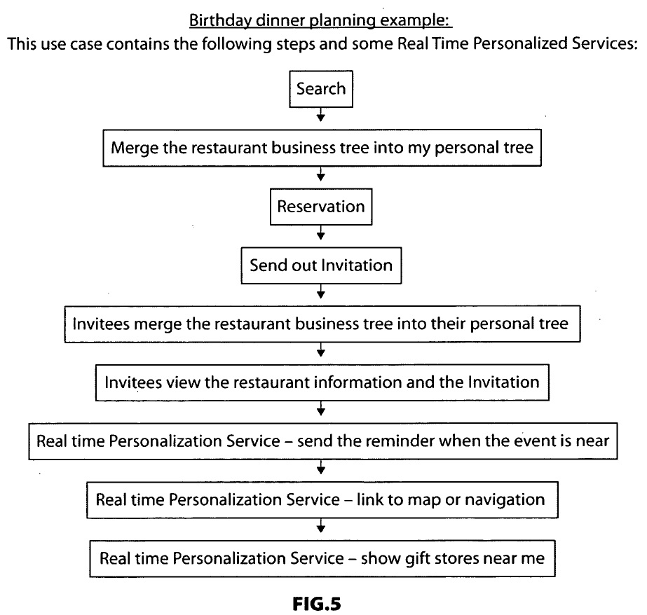

FIG. 5 is an illustrative process for planning a birthday dinner using the inventive application. In the example shown in FIG. 5, a user may wish to plan a birthday dinner for the user's son. The son tells the user what type of food he would like, and the user goes to the inventive tree platform and searches for participating restaurants that have compatible branches for use on the user's inventive platform. After reading the reviews and selecting a particular restaurant, the restaurant's branch is merged onto the user's tree.

In FIG. 5, after merging the restaurant tree into the user's personal tree, the user makes reservation using the restaurant's application. The restaurant's application may have an invite function that sends out invitations to guests. The user's birthday guests can receive a branch of the restaurant's application, which can then be downloaded into the guests own respective personal trees. Various functionalities such as weather, traffic, GPS, calendar reminders, reviews, changes in reservations, among other functionalities can be coupled to the restaurant branch. As the son's birthday approaches, based on prior histories, prior buying patterns, and other relevant data, the user gets targeted advertisement from area stores where the son likes to shop.

Another embodiment of the inventive application allows the user to personalize and create in advance an application for an upcoming trip. For example, a user may wish to travel to Las Vegas as shown in FIG. 9B. In anticipation of an upcoming trip, a user is also able to create personalized trees or branches concerning the trip. The user may create a branch in the user's inventive tree titled “Vegas trip”.

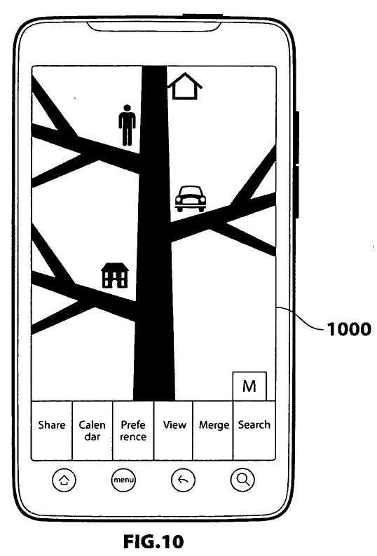

The user will be able to search for and download various compatible applications from participating vendors in anticipation of various needs that will come up during the visit. For example, among various needs that may be anticipated, hotel lodging, airline tickets, car rental, show reservations, traffic information, weather information, and restaurant reservations as shown in FIG. 9B. The tree-view format display 1000 of FIG. 9B is also shown in FIG. 10.

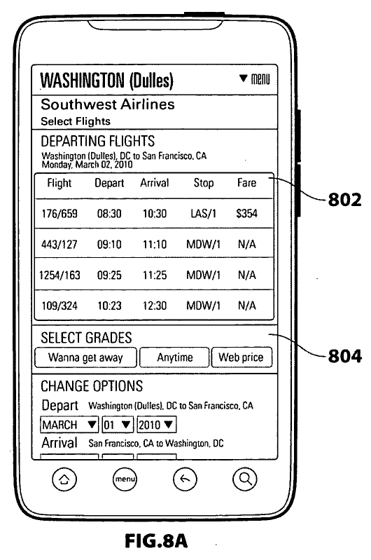

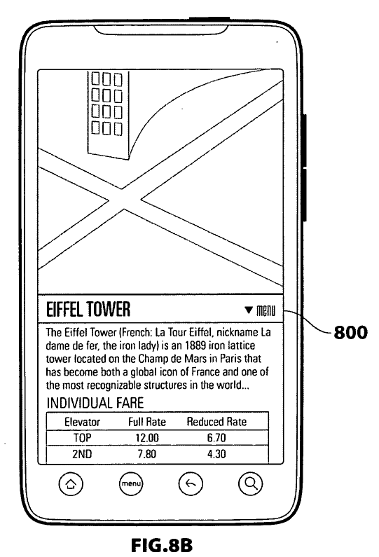

Within the user's platform, the user will do a search for each one of these topics and choose a participating vendor to download a compatible application. Arrangements are made in advance for each of these categories mentioned. For example, as shown in FIG. 8A, airline tickets can be purchased after downloading a participating airline's compatible branch. The airline application branch can send reminders or can provide GPS enabled direction onto the mobile device display. The user may check in using the application, change seats, and make other reservation functionalities 804, and even check the departing time 802 of the flight. During the flight, the user may use the airline's tree to purchase drinks and order movies, track whether the bags made it onto the flight, and check arrival time. After the flight, the user may manage frequent flier miles from the airline, give feed back about the flight, and arrange for the return flight and purchase tickets.

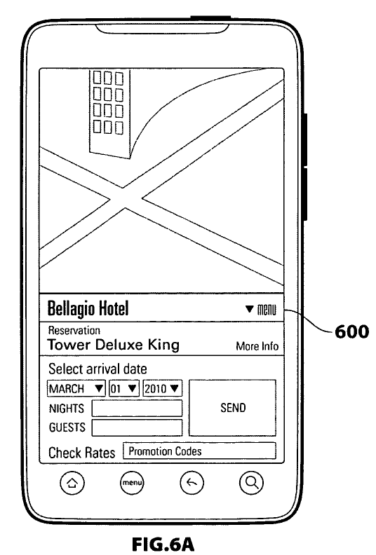

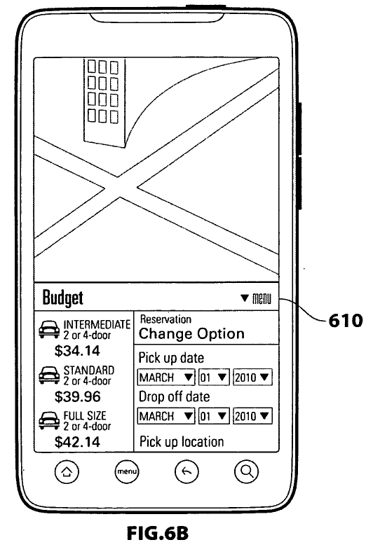

Upon arrival in Vegas, as shown in FIG. 6A, the user's previously merged Bellagio Hotel tree 600 checks in the user and contacts the hotel for a shuttle. If 12 reservations had not yet been made, through the user's real time personalization service, a prompt may be sent requesting whether the user would like information about available dining options. From the “suggested lists”, the user selects the place to visit by looking at Yelp reviews listed alongside the restaurants tree.

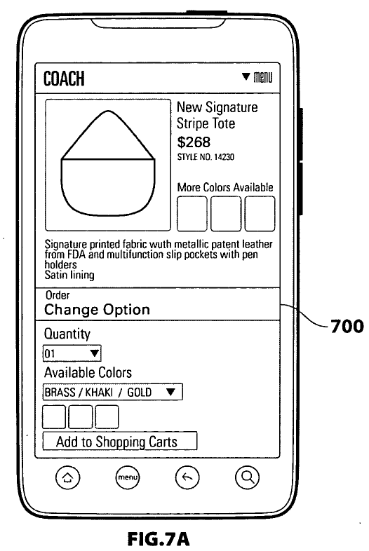

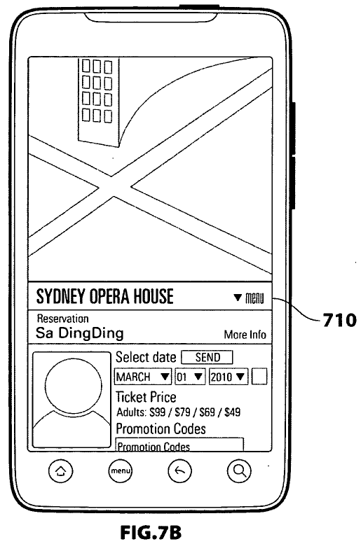

Additional examples of eCommerce options are shown in FIG. 6B showing a user interface 610 for car rental using the inventive application, in FIG. 7A showing a user interface 700 for purchasing a woman's hand bag, in FIG. 7B showing a user interface 710 for purchasing opera tickets, in FIG. 8B showing user interface 800 for obtaining information 900 about the Eiffel Tower, and in FIG. 9A showing user interface for obtaining information about a convention center.

After or during the user's trip to Vegas, the user will be able to take photos from the mobile device, attach it and send it to friends, upload it onto Facebook, and otherwise cross-reference and use it for any other branches on the user's tree.

The user can share the Vegas tree/branch with any of the user's friends or family by sending them the user's Vegas branch. This entire process can be prepared by a third party and custom tailored for the user, for example the user's personal administrative assistant, can in advance create the Vegas tree/branch and send it to the user to merge in anticipation of upcoming trip.

In another example, a user uses the inventive application to hire a baby sitter in an emergency situation. For example, a user normally picks up her son at 6 pm every day. On one day, a work emergency prohibits the user from leaving her work on time. The user searches for a baby sitter near her home using a search engine. From the search result, which displays various baby sitters who have compatible downloadable content, the user finds a Pepperdine student, who is recommended by a baby sitting referral service. The user calls the baby sitter to do a quick phone interview (via video chat or phone call), and the user decides to hire the baby sitter. The user may ask the baby sitter to send her information to the user and the user's son. The baby sitter goes to her tree and sends her informational branch, which may include her phone number, photo, resume, and reference numbers. The user and the son merge the baby sitter's information onto their individual trees. When the baby sitter is on her way to pick up the user's son, she send a “MeetAt” Notification to the son and the son can see her GPS position and the time when she will arrive to pick him up. The user can track both of them from her telephone via a GPS tracking device for both the son and the baby sitter. After the son is picked up, he goes into his Personal Tree and sends a message to the user that he has been picked up.

The method in which weight is assigned by the search application of the inventive application concerns assigning different weight or importance to various actions taken by the user. For example, when a user searches for and find a compatible application, the user can view or access the compatible application. A user viewing or accessing a compatible application can be given a weight of 1, for example. When a user downloads or merges the compatible application directly with the user's inventive application, a higher weight is given, because this signifies that the user has taken a much more concrete and important step with the content provider's compatible application. In this example, a numerical weight of 3 is assigned. A user choosing the merge option would result in a score of 3 because this indicates the consumer's desire to continue using the content and functionality within the tree. But when a user conducts a commercial activity using the content provider's compatible application, for example, purchasing a good or service or setting an appointment, an even higher weight, for example 6, can be assigned to that action taken by the user. A function performed on the tree gives the highest score of 6 because this indicates the importance and usefulness of a business function from consumer's experience. All of the different user's behavior or even a specific user's behavior could be compiled to assign a rank to a content provider's compatible application. Also different weight given to each action, whether viewing, accessing, downloading, merging, or conducting any one or more functionalities, can change as needed.

This is one example of the way in which results can be ranked. Higher ranked results can be displayed higher in the results. Any other methods for ranking and sorting search results can also be used as known in the art.

As an example, the following are the two BMW dealers using the ranking method as described:

BMW dealer #1

| | |
|---|---|
| View/Access | 100 times |
| Download/Merge | 20 times |
| Function performed | 10 times |

Rank: (100 × 1) + (20 × 3) + (10 × 6) = 220

BMW dealer #2

| | |
|---|---|
| View/Access | 100 times |
| Download/Merge | 30 times |
| Function performed | 15 times |

Rank: (100 × 1) + (30 × 3) + (15 × 6) = 280

Since BMW dealer #2 has a higher rank, when users search BMW dealer, the search result will show the BMW #2 dealer on the top and BMW dealer #1 is next.

In other embodiments, the user can override the default ranking system assigned and custom tailor their own ranking values. For example, the ranking can be location specific, price specific, or user review specific. For example, the user may search for results within 10 miles of the user's current location according to geocode. For example, the user may search for results based on price. Also, the user may request restaurants based on user reviews. The user can select criteria that override default search weighing/ranking criteria.

The present invention concerns an inventive application for use with electronic devices, preferably portable, more preferably handheld portable computing devices, most preferably portable smart phones, which generally possess an interface, circuitry, storage, memory, user interface, such as input and output, displays, and communication mechanism, as known in the art.

The types of devices used include handheld and portable electronic devices, MP3 players, smart phones (such as iPhone, Blackberry, and Android/Google phones). Also portable tabs such as iPad and portable tablets are also contemplated, as well as e-readers such as ones produced by Amazon or Barnes and Noble.

Various components as known in the art, for example, descriptions concerning storage, local and remote, memory including cache, RAM, semi permanent, and permanent, input and output such as key pads, buttons, touch screens, voice, infrared, keyboards, projections, and other communication technologies such as wireless, Wi-Fi, infrared, cellular, VoIP, synching and data transfer, data back up and system software, battery charging, and connections, as known in the art, for example known technologies as described in U.S. Patent Publication Number 2010/0191551 A1 as in paragraphs 0022-0035 are incorporated herein by reference.

1. A method for allowing a user to use an application on a portable electronic device to find and merge compatible content comprising:
downloading or installing said application onto said portable electronic device to provide a display comprising one or more point of interest, wherein said points of interest comprise associated geospatial information,
wherein said display can be configured in one or more views selected from:
view showing said points of interest in a map as a background, wherein said map may be scalable or non-scalable,
view showing said points of interest in an outline or folder format, and
view showing said points of interests in a schematic format of organization,
searching for and displaying one or more compatible content,
wherein said compatible content comprises one or more of: information, interactive functionality, and application, and
wherein said compatible content is viewable, accessible, downloadable, merge-able, or compatible for interaction with said application;
viewing or accessing said one or more compatible content,
downloading or merging a selected compatible content selected from said one or more compatible content,
whereby provider of said selected compatible content pays the operator of said application when one or more of the following actions are completed:
viewing said selected compatible content,
accessing said selected compatible content,
downloading said selected compatible content,
merging said selected compatible content, and
completing a functionality using said selected compatible content,
wherein the search result from the inventive platform is user-influenced in that the more a compatible application of a content provider is viewed, merged or commercial activity performed, the higher its rank.

2. The method according to claim 1, wherein a user downloading or installing said application onto said portable electronic device does not pay a fee to the application operator or provider.

3. The method according to claim 1, wherein provider of said selected compatible content creates compatible content using methods provided by the application operator or provider without paying a fee.

4. The method according to claim 1, wherein said selected compatible content upon being merged is displayed as an additional point of interest.

5. The method according to claim 1, wherein said selected compatible content upon being merged allows a user to access said selected compatible content for viewing information or conducting a functionality.

6. The method according to claim 1, further comprising archiving or storing away from view said selected compatible content.

7. The method according to claim 1, wherein said provider of said selected compatible content updates or interacts with said selected compatible content after merging or downloading.

8. The method according to claim 1, wherein said provider of said selected compatible content updates or interacts with said application.

9. The method according to claim 1, further comprising sharing one or more points of interest from one user of said application to another user.

10. The method according to claim 1, further comprising delivering time specific, location specific, preference specific, or event specific compatible content to said selected compatible content on said application.

11. The method according to claim 1, wherein a user downloading or merging said selected compatible content can choose between available options of different compatible content available within said selected compatible content.

12. The method according to claim 1, further comprising ranking search results by assigning value based on weight of user activity.

13. The method according to claim 1, wherein said portable electronic device is a mobile telephone.

14. The method according to claim 1, wherein said portable electronic device is a mobile telephone with an interactive display screen.

15. The method according to claim 1, wherein said schematic view organizes said points of interest in a tree and branches format.

16. The method according to claim 1, wherein said application provides automated, real time personalization service based on said user's preferences which can be set in advance.

17. A method for allowing a user to use an application on a portable electronic device to find and merge compatible content comprising:
downloading or installing said application onto said portable electronic device to provide a display comprising one or more point of interest, wherein said points of interest comprise associated geospatial information,
wherein said display can be configured in one or more views selected from:
view showing said points of interest in a map as a background, wherein said map may be scalable or non-scalable,
view showing said points of interest in an outline or folder format, and
view showing said points of interests in a schematic format of organization,
searching for and displaying one or more compatible content,
wherein said compatible content comprises one or more of: information, interactive functionality, and application, and
wherein said compatible content is viewable, accessible, downloadable, merge-able, or compatible for interaction with said application;
viewing or accessing said one or more compatible content,
downloading or merging a selected compatible content selected from said one or more compatible content,
whereby provider of said selected compatible content pays the operator of said application when one or more of the following actions are completed:
viewing said selected compatible content,
accessing said selected compatible content,
downloading said selected compatible content,
merging said selected compatible content, and
completing a functionality using said selected compatible content.
